(19) United States
(12) Patent Application Publication
(10) Pub. No.: US 2002/0035830 A1
(43) Pub. Date: Mar. 28, 2002

(54) Reversible recuperator

(76) Inventors: Karl Fleer, San Pedro, CA (US); Hammoud Ahmed, Cypress, CA (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/511,473

(22) Filed: Feb. 23, 2000

(51) Int. Cl. F02C 7/10

(52) U.S. Cl. 60/39.511

(57) ABSTRACT

A recuperator movable between a first position and a second position in or relative to a power generating system. When the recuperator is in the first position, a gas side inlet of the recuperator is coupled to a turbine exhaust outlet of the turbomachine. When the recuperator is in the second position, a gas side outlet of the recuperator is coupled to the turbine exhaust outlet, whereby the direction of gas flow inside the recuperator is reversed. Reversing the gas flow direction extends the life of the recuperator by reducing the total amount of time that the gas inlet face is exposed to high temperatures. Reversing the gas flow direction also allows for the removal of condensation of exhaust gas byproducts on cooler passage surfaces of the recuperator gas side. It is emphasized that this abstract is provided to comply with the rules requiring an abstract that will allow a searcher or other reader to ascertain quickly the subject matter of the technical disclosure. The abstract is submitted with the understanding that it will not be used to interpret or limit the scope or meaning of the claims. 37 C.F.R. 1.72(b).

### BACKGROUND OF THE INVENTION

This invention relates generally to heat exchangers for power generating systems. A specific embodiment relates to recuperators for turbomachinery. The present invention also relates to microturbine power generating systems, which are small, multi-fuel, modular distributed generation units.

Although the recuperator of the present invention can be used with stationary microturbines, with other turbomachinery (such as turbomachinery used for automotive and air transportation), and with other power generating systems such as fuel cells, the recuperator is described here for convenience primarily in connection with microturbines. Microturbine power generating systems generally includes a combustor, a turbine stage, a compressor stage and an electrical generator. A microturbine power generating system may also include a recuperator for transferring heat from hot exhaust gas leaving the turbine stage to compressed air entering the combustor. Transferring the heat raises the temperature of the air entering the combustor and cools the exhaust gas leaving the turbine stage. Raising the temperature of the compressed air enhances combustion and increases efficiency of the system.

There are potential problems associated with the recuperator. One potential problem arises from thermal stresses in the recuperator. The turbine exhaust gas entering the recuperator is hotter than the exhaust gas leaving the recuperator. Consequently, the front face of the recuperator is hotter than the exit face. The resulting thermal stresses can reduce the operating life of the recuperator.

Another potential problem is associated with the buildup of combustion products in the recuperator. As the exhaust gas is passing through the recuperator, combustion products in the exhaust gas can condense and build up on cooler heat transfer surfaces of the recuperator. The buildup can decrease heat transfer efficiency. The buildup can also restrict the flow of exhaust gas and thereby reduce system efficiency. The recuperator may be cleaned periodically, but the periodic cleaning would increase the cost of maintaining the microturbine power generating system.

### SUMMARY OF THE INVENTION

The present invention may be regarded as a recuperator movable between a first position and a second position in a power generating system such as a microturbine. When the recuperator is in the first position, a gas side inlet of the recuperator is coupled to a turbine exhaust outlet of the microturbine. When the recuperator is in the second position, a gas side outlet of the recuperator is coupled to the turbine exhaust outlet, whereby the direction of gas flow inside the recuperator is reversed. Reversing the gas flow direction reduces the total amount of time that the hotter sections of the recuperator are exposed to higher temperatures, thereby extending the life of the recuperator. Reversing the gas flow direction also allows deposited combustion products to be removed from the heat transfer surfaces of the recuperator, resulting in a self-cleaning feature that reduces maintenance of the power generating system.

### BRIEF DESCRIPTION OF THE DRAWINGS

FIG. 1 is a block diagram of a power generating system according to the present invention, the power generating system including a recuperator;

FIG. 2 is an illustration of a core of the recuperator;

FIGS. 3a and 3b are illustrations of the recuperator in first and second positions; and

FIG. 4 is a flowchart of a method of using the recuperator.

### DETAILED DESCRIPTION OF THE INVENTION

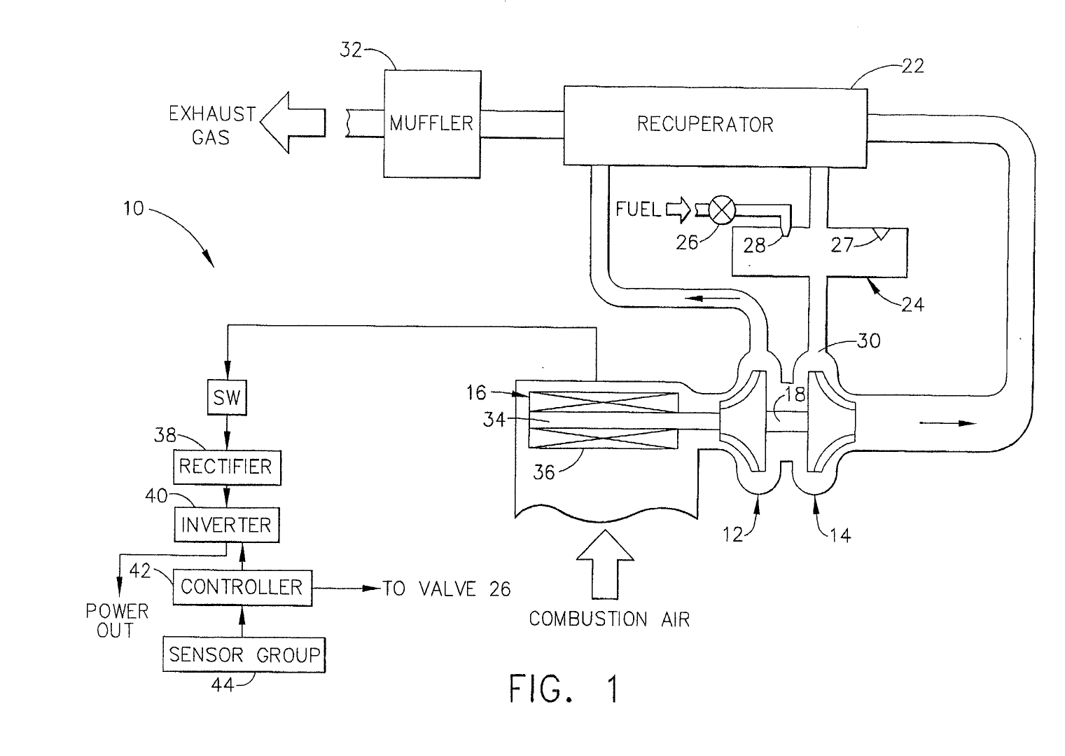

FIG. 1 shows a power generating system 10 including a compressor 12, a turbine 14 and an electrical generator 16 cantilevered from the compressor 12. The compressor 12, the turbine 14 and the electrical generator 16 are rotated by a single common shaft 18. Although the compressor 12, turbine 14 and electrical generator 16 may be mounted to separate shafts, the use of the single common shaft 18 adds to the compactness and reliability of the power generating system 10.

The shaft 18 may be supported by self-pressurized air bearings such as foil bearings. Foil bearings eliminate the need for a separate bearing lubrication system and reduce the occurrence of maintenance servicing.

Air is compressed by the compressor 12, and the compressed air is circulated through air side passages of a recuperator 22. Compressed air leaving the air side passages of the recuperator 22 is supplied to a combustor 24.

Fuel is also supplied to the combustor 24. Either gaseous or liquid fuel may be used. Choices of fuel include diesel, flare gas, wellhead natural gas, waste hydrocarbon fuel streams, gasoline, naphtha, propane, JP-8, methane, natural gas and other man-made gases.

The flow of fuel to the combustor 24 is controlled by a flow control valve 26. The fuel is injected into the combustor 24 by an injection nozzle 28.

Inside the combustor 24 the fuel and compressed air are mixed and ignited by an igniter 27 in an exothermic reaction. Hot, expanding gases resulting from combustion in the combustor 24 are directed to an inlet nozzle 30 of the turbine 14. The inlet nozzle 30 may have a fixed geometry. The hot, expanding gases resulting from the combustion are expanded through the turbine 14, thereby creating turbine power. The turbine power, in turn, drives the compressor 12 and the electrical generator 16. For transportation applications, the generator may be reduced in size or eliminated, and the excess resulting power supplied to a drive train.

Turbine exhaust gas is passed through gas side passages of the recuperator 22. Inside the recuperator 22, heat from the turbine exhaust gas in the gas side passages is transferred to the compressed air in the air side passages. In this manner, some heat of combustion is recuperated and used to raise the temperature of the compressed air en route to the combustor 24. After surrendering part of its heat, the turbine exhaust gas exits the recuperator 22. Additional heat recovery stages may be added onto the power generating system 10. A muffler 32 reduces the noise created by the turbine exhaust gas leaving the recuperator 22.

The generator 16 may be a ring-wound, two-pole toothless (TPTL) brushless permanent magnet machine having a permanent magnet rotor 34 and stator windings 36. The rotor 34 is attached to the shaft 18. When the rotor 34 is rotated by the turbine 14, an alternating current is induced in the stator windings 36. Speed of the turbine 34 can be varied in accordance with external energy demands placed on the system 10. Variations in the turbine speed will produce a variation in the frequency of the alternating current generated by the electrical generator 16. Regardless of the frequency of the ac power generated by the electrical generator 16, the ac power can be rectified to dc power by a rectifier 38, and then chopped by a solid-state electronic inverter 40 to produce ac power having a fixed frequency. Accordingly, when less power is required, the turbine speed can be reduced without affecting the frequency of the ac output.

Use of the rectifier 38 and the inverter 40 allows for wide flexibility in determining the electric utility service to be provided by the power generating system 10 of the present invention. Because any inverter 40 can be selected, frequency of the ac power can be selected by the consumer. If there is a direct use for ac power at wild frequencies, the rectifier 38 and inverter 40 can be eliminated.

A controller 42 controls the turbine speed by controlling the amount of fuel flowing to the combustor 24. The controller 42 uses sensor signals generated by a sensor group 44 to determine the external demands upon the power generating system 10 and then controls the fuel valve 26 accordingly. The sensor group 44 could include sensors such as position sensors, turbine speed sensors and various temperature and pressure sensors for measuring operating temperatures and pressures in the system 10. Using the aforementioned sensors, the controller 42 can control both startup and optimal performance during steady state operation.

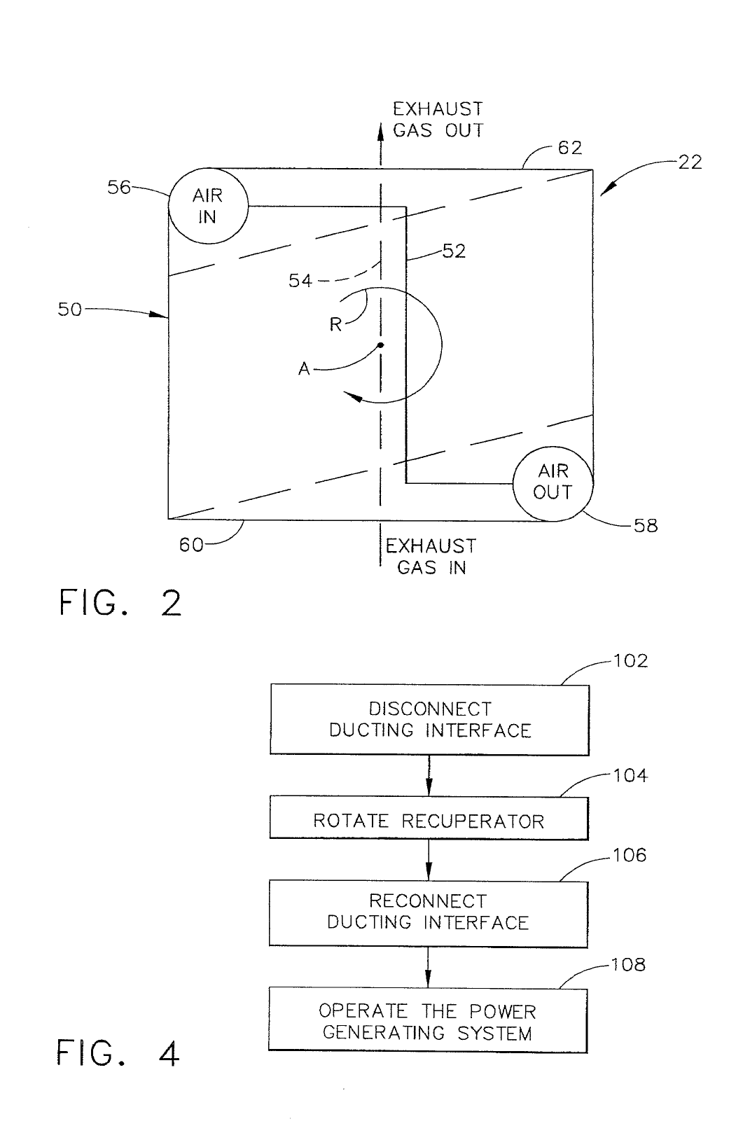

Reference is now made to FIG. 2. The recuperator 22 includes a heat exchanger core 50 having a standard construction. Air and gas side passages 52 and 54 are formed within the heat exchanger core 50. The heat exchanger core 50 may be made of a stack of plates that form the air and gas side passages 52 and 54.

Compressed air is supplied to an air inlet manifold 56, which distributes the compressed air to the air side passages 52 in the heat exchanger core 50. Air leaving the air side passages 52 is collected by an air outlet manifold 58. The air manifolds 56 and 58 may be formed integrally with the heat exchanger core 50. For example, the air manifolds 56 and 58 may be formed by the plates.

The turbine exhaust gas stream enters a first face 60 of the heat exchanger core 50, flows through the gas passages 54 in the core 50, and exits from a second face 62 of the heat exchanger core 50. As the air flows across the core 50, heat is transferred from the exhaust gas to the compressed air. However, as the turbine exhaust gas is passing through the gas side passages 54, combustion products in the turbine exhaust gas can condense and build up on cooler sections of the gas side passages 54. This buildup can decrease heat transfer efficiency. The buildup can also restrict the flow of turbine exhaust gas and thereby reduce system efficiency.

The heat exchanger core 50 can be rotated by 180 degrees about a pivot point A, whereby the positions of the inlet and outlet manifolds 56 and 58 are reversed. A direction of rotation is indicated by the arrow R. When the core 50 is rotated by 180 degrees, the air and gas flow directions are reversed. Air flows into the air outlet manifold 58 and out of the air inlet manifold 56. Turbine exhaust gas enters the second face 62 of the heat exchanger core 50 and exits from the first face 60. Reversing the gas flow direction allows deposited combustion products to be removed from the heat transfer surfaces of the recuperator 22. Reversing the gas flow direction also reduces the total amount of time that the hotter sections of the recuperator 22 are exposed to higher temperatures, thereby extending the life of the recuperator 22.

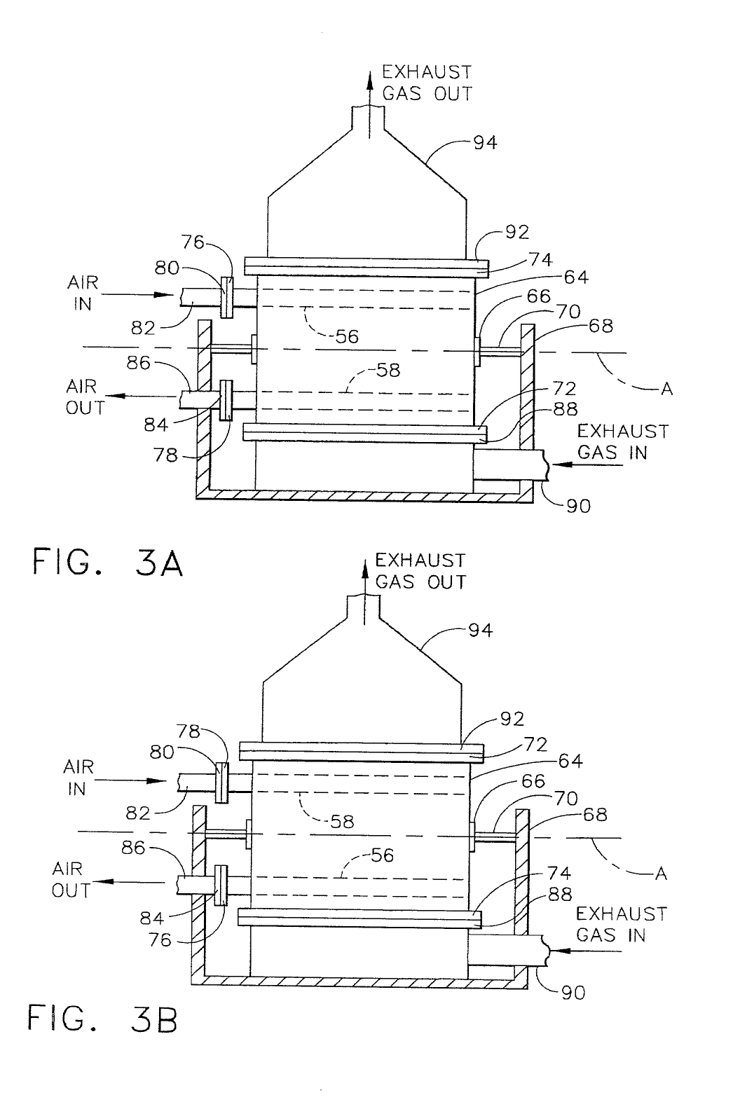

Reference is now made to FIGS. 3A and 3B. The recuperator 22 further includes a casing 64 for the heat exchanger core 50. The casing 64 has external insulation (not shown) and mounting brackets 66.

The recuperator 22 is mounted on a mounting stand 68. The stand 68 includes mounting pins 70 that are pivotally attached to the mounting brackets 66. The mounting stand 68 allows the recuperator 22 to be rotated about the axis A, which extends through the mounting pins 70. The recuperator 22 can be rotated between a first position (shown in FIG. 3a) and a second position (shown in FIG. 3B). Rotating the recuperator 22 from the first position to the second position (or vice versa) causes the air and gas flow directions inside the recuperator 22 to be reversed.

The casing 64 also provides a ducting interface for the recuperator 22. The ducting interface includes a gas side inlet flange 72, a gas side outlet flange 74, an air inlet flange 76, and an air outlet flange 78.

When the recuperator 22 is in the first position, the ducting interface flanges are attached as follows. The air inlet flange 76 is connected to a flange 80 on a first duct 82, which places the air inlet manifold 56 in fluid communication with an outlet of the compressor 12. The air outlet flange 78 is connected to a flange 84 on a second duct 86, which places the air outlet manifold 58 in fluid communication with an air inlet of the combustor 24. The gas inlet flange 72 is connected to a flange 88 on a third duct 90, which places the bottom face 60 of the heat exchanger core 50 in fluid communication with an exhaust outlet of the turbine 14. The gas outlet flange 74 is connected to a flange 92 on a fourth duct 94, which places the top face 62 of the heat exchanger core 50 in fluid communication with an inlet of the muffler 32.

Additional reference is now made to FIG. 4. After the recuperator 22 has been used over a period of time, the flanges 72, 74, 76 and 78 of the ducting interface are disconnected (step 102), and the recuperator 22 is rotated from the first position to the second position (step 104). This step may be accomplished in one of several ways. The recuperator 22 can be shaped so as to be rotatable in-situ on mounting pins 70, without requiring any movement of flanges 88 or 92 relative to one another or to the mounting stand 68. Or, mounting pins 70 can be slideably attached to mounting stand 68 or mounting brackets 66, thereby allowing recuperator 22 to be slid out from between flanges 88 and 92, rotated on mounting pins 70, and re-inserted in reverse-flow position between flanges 88 and 92. Alternatively, the fourth duct 94 and flange 92 could be removed from the system 10; the recuperator 22 detached from the other ducts of the system 10, lifted, rotated, replaced on flange 88 in reverse-flow position; and the fourth duct 94 and flange 92 remounted in the system 10. This latter approach, of course, would allow the use of a mounting mechanism that does not require mounting pins 70 that are pivotally attached to mounting brackets 66. Still other approaches can be used.

The recuperator 22 may have any or all of the following design features: air inlet and outlet flanges 76 and 78 that are located symmetrically or near-symmetrically with respect to the axis of rotation A; gas inlet and outlet flanges 72 and 74 that are located symmetrically or near-symmetrically about the axis A of rotation; and symmetrically-opposed flanges that have the same bolt patterns. The system 10 may have any or all of the following design features: air inlet and outlet ducts 82 and 86 that are sized similarly; gas inlet and outlet ducts 90 and 92 that are sized similarly; and symmetrically-opposed flanges that have the same bolt patterns. Each of these design features reduces the amount of work needed to disconnect and reconnect the recuperator 22 in the system 10.

Following step 104, the flanges 72, 74, 76 and 78 of the mounting interface are reconnected (step 106). The air inlet flange 76 is reconnected to the flange 84 on the second duct 86, which places the air inlet manifold 56 in fluid communication with an air inlet of the combustor 24. The air outlet flange 78 is connected to the flange 80 on the first duct 82, which places the air outlet manifold 58 in fluid communication with the compressor outlet. The gas inlet flange 72 is connected to the flange 92 on the fourth duct 94, which places the bottom face 60 of the heat exchanger core 50 in fluid communication with the muffler inlet. The gas outlet flange 74 is connected to the flange 88 on the third duct 90, which places the top face 62 of the heat exchanger core 50 in fluid communication with the turbine exhaust outlet.

The power generating system 10 is operated (Step 108). Previously hotter sections of the recuperator 22 now become subjected to cooler temperatures, thereby extending the useful life of the recuperator 22. Additionally, combustion products that were deposited on the gas passages 54 near the colder gas outlet (prior to reversal) are now near the hotter gas inlet (after reversal). Further operation of the turbine 14 causes the deposited products near the gas inlet to be burned off and removed. Resulting is a self-cleaning feature of the recuperator 22.

After the recuperator 22 has been operated over an additional period of time, the recuperator 22 may be rotated back to the first position. The position of the recuperator 22 can be changed at any time. For example, the recuperator position could be changed halfway through the operating life, or the recuperator position could be changed whenever the microturbine power generating system 10 is overhauled.

Thus disclosed is a recuperator that can be rotated so that gas side passages are reversed. Reversing the gas side passages allows deposited combustion products to be removed and thereby improves heat transfer efficiency and exhaust gas through-flow. Reversing the gas side passages also reduces overall thermal stresses, which allows creep criteria to be relaxed (hotter sections of the core are designed by creep criteria; the creep criteria accounts for steady-state and transient temperature stresses in the core), the recuperator life to be extended, or thinner materials to be used to produce a smaller, lighter, lower cost recuperator.

The present invention is not limited to the specific embodiments disclosed above. For example the heat exchanger core could have a crossflow configuration instead of a counterflow configuration. An axis of rotation might be chosen such that the gas flow direction is reversed but the airflow direction is not reversed. The recuperator could be designed such that only the top and bottom faces of the heat exchanger core are rotated (and the inlet and outlet manifolds are not rotated). Configuration, geometry and dimensions of the recuperator will depend upon the intended application.

The recuperator interfaces may or may not be connected to ducts. Instead, certain recuperator interfaces may be mounted directly to flanges on the combustor, muffler and turbine. The heat exchanger core of the recuperator may be a prime surface heat exchanger core or an extended surface (i.e., plate fin) heat exchanger core.

In addition, the recuperator of the present invention could be used in a power generating system that does not use a turbomachine, such as a fuel cell power generating system.

Therefore, the present invention is not limited to the specific embodiments disclosed above. Instead, the present invention is construed according to the claims that follow.

What is claimed is:

1. A power generating system comprising:
a power generator having an exhaust outlet; and
a recuperator disposed downstream the exhaust outlet, the recuperator being movable between first and second positions, the recuperator including a gas side inlet and a gas side outlet, the gas side inlet being connected to the exhaust outlet when the recuperator is in the first position, the gas side outlet being connected to the exhaust outlet when the recuperator is in the second position.

2. The system of claim 1, further comprising a stand, the stand supporting the recuperator and allowing the recuperator to be rotated in-situ between the first and second positions.

3. The system of claim 1, further comprising a stand, the stand supporting the recuperator and allowing the recuperator to be slideably removed from its first position in the power generating system, rotated, and replaced in its second position in the power generating system.

4. The system of claim 1, wherein the recuperator is rotatable about an axis of rotation, and wherein the gas side inlet and gas side outlet are symmetrical about the axis of rotation.

5. The system of claim 1, wherein the recuperator is rotatable about an axis of rotation, and wherein the airside inlet and air side outlet are symmetrical about the axis of rotation.

6. The system of claim 1, wherein the recuperator includes a heat exchanger core having a counterflow design.

7. The system of claim 1, wherein the power generating system is a microturbine power generating system and the exhaust outlet is a turbine exhaust outlet.

8. The system of claim 7, wherein each of the recuperator gas side inlet, recuperator gas side outlet, and turbine exhaust outlet has a flange, said recuperator gas outlet flange and recuperator gas inlet flange both being sized and positioned to mate with said turbine exhaust outlet flange.

9. A recuperator comprising:
a heat exchanger core having a gas side and an air side, the heat exchanger core being rotatable about an axis;
a gas side inlet flange at an inlet of the gas side and a gas side outlet flange at an outlet of the gas side, the gas side inlet and outlet flanges being arranged symmetrically about the axis of rotation; and
an air side inlet flange at an inlet of the air side and an air side outlet flange at an outlet of the air side, the air side inlet and outlet flanges also being arranged symmetrically about the axis of rotation;
positions of the gas side flanges being reversed when the recuperator is rotated by 180 degrees about the axis of rotation;
positions of the air side flanges being reversed when the recuperator is rotated by 180 degrees about the axis of rotation.

10. The recuperator of claim 9, wherein the heat exchanger core has a counterflow design.

11. The recuperator of claim 9, further comprising mounting brackets for pivotally mounting the heat exchanger core.

12. A method of using a recuperator with a turbomachine, the recuperator including a gas side inlet and a gas side outlet, the turbomachine including a turbine exhaust outlet, the gas side inlet of the recuperator being coupled to the turbine exhaust outlet of the turbomachine in a first position, the method comprising the steps of:
decoupling the gas side inlet of the recuperator from the turbine exhaust outlet of the turbomachine; and
recoupling the gas side outlet of the recuperator to the turbine exhaust outlet of the turbomachine in a second position.

13. The method of claim 12, further comprising the step of operating the turbomachine to clean the gas side of the recuperator, the turbomachine being operated after the gas side outlet of the turbomachine has been recoupled to the turbine exhaust outlet of the recuperator.

14. The method of claim 12, further comprising the steps of decoupling a recuperator air side inlet from a compressor outlet; decoupling a recuperator air side outlet from a combustor inlet; recoupling the air side inlet to the combustor inlet; and recoupling the air side outlet to the compressor outlet.

15. The method of claim 12, further comprising the step of rotating the recuperator about an axis from the first position to the second position, the recuperator being rotated after the gas side inlet of the recuperator has been decoupled from the turbine exhaust outlet of the turbomachine, the gas side outlet of the recuperator being recoupled to the turbine exhaust outlet of the turbomachine after the recuperator has been rotated to the second position.

16. The method of claim 15, further comprising the steps of providing a mounting stand for the recuperator, whereby the recuperator can be slid relative to the mounting stand and removed from the turbine exhaust outlet of the turbomachine after the recuperator is decoupled therefrom; and, prior to the step of rotating the recuperator, sliding the recuperator relative to the mounting stand and the turbine exhaust outlet.
